(19) United States
(12) Patent Application Publication
(10) Pub. No.: US 2007/0228760 A1
(43) Pub. Date: Oct. 4, 2007

(54) WEAR INDICATING LINER FOR VEHICLE BED

(76) Inventor: MICHAEL CRAMARO, Indian Harbor Beach, FL (US)

Correspondence Address: Connolly Bove Lodge & Hutz, LLP, P.O. Box 2207, Wilmington, DE, 19899-2207, US

(21) Appl. No.: 11/691,599

(22) Filed: Mar. 27, 2007

Related U.S. Application Data
(60) Provisional application No. 60/787,242, filed on Mar. 30, 2006.

(51) Int. Cl. B62D 33/00

(52) U.S. Cl. 296/39.2; 156/308.2; 156/94

(57) ABSTRACT

A wear indicating liner for a vehicle bed comprises a top layer and a bottom layer made of materials which are visually distinct from each other. As a result when the bottom layer begins to be visible after wear through the top layer there is a visual indication that there has been a significant amount of wear of the liner.

### CROSS-REFERENCE TO RELATED APPLICATION

This application is based upon provisional application Ser. No. 60/787,242, filed Mar. 30, 2006, all of the details of which are incorporated herein by reference thereto.

### BACKGROUND OF THE INVENTION

Liners are frequently used on top of a vehicle bed to protect the vehicle bed from the materials placed in the bed. Over a period of time periodic loading and unloading of the materials causes wear through the liner thereby requiring replacement of the liner or else resulting in damage to the vehicle bed. Bed liners are also used to facilitate the unloading of, for example, sticky materials or materials frozen together when the unloading is in cold climates.

It has been suggested that a bed liner could be made of two layers of material in order to reduce costs by making the bottom layer, which is disposed on the vehicle bed, of a cheaper material such as a reprocessed material. Where different materials are used the layers might be of different colors. This suggestion for using different materials to form the liner is intended to result in a cheaper liner and did not include any recognition that such liner could further be adapted to have any wear indicating functions.

### SUMMARY OF THE INVENTION

An object of this invention is to provide a wear indicating liner for a vehicle bed.

A further object of this invention is to provide such a liner which readily indicates through normal usage when there has been a significant amount of wear of the liner.

In accordance with this invention the liner for a vehicle bed includes a top layer and a bottom layer mounted below and secured to the top layer. The top layer and the bottom layer are made of materials which are visually distinct from each other. As a result, when the bottom layer begins to be visible after wear through the top layer there is a clear visual indication that a significant amount of wear has resulted in the liner.

The top layer and bottom layer could be visually distinct from each other by being made of different colors such as a gold color top layer and black bottom layer. In a preferred practice of the invention the two layers are also made of different thicknesses with the top layer preferably being a substantially thicker layer and made of a heavy duty material as compared to the softer thinner bottom layer. The two layers could be secured together in any suitable manner such as by co-extrusion or by being physically distinct layers laminated together.

### THE DRAWINGS

FIG. 1 illustrates a side elevational view of a portion of a vehicle bed having a liner mounted thereon in accordance with this invention; and

FIG. 2 is a top plan view showing the liner of FIG. 1 mounted on top of a vehicle bed.

### DETAILED DESCRIPTION

The present invention is directed to improvements in a bed liner for vehicle beds. Such liners are known for various types of vehicle beds such as for dump trucks or other types of trucks. In practice, various articles or other contents would be placed in the bed. The provision of a liner on top of the upper surface of the bed protects the bed from damage that would otherwise result. During use the liner wears through and if not timely replaced the contents in the vehicle body would contact the vehicle bed and could cause damage to the bed. Such damage could be avoided by periodically replacing the liner. When, however, the liner is prematurely replaced there is an unnecessary cost by discarding a liner still having a useful amount of life. In addition, there is unnecessary effort in removing the old liner and installing the new liner.

The present invention relates to the provision of a liner 10 which would be mounted over a vehicle bed 12. Liner 10 is constructed in such a manner as to be a wear indicating liner so as to provide a clear indication of the optimum time for replacing the liner.

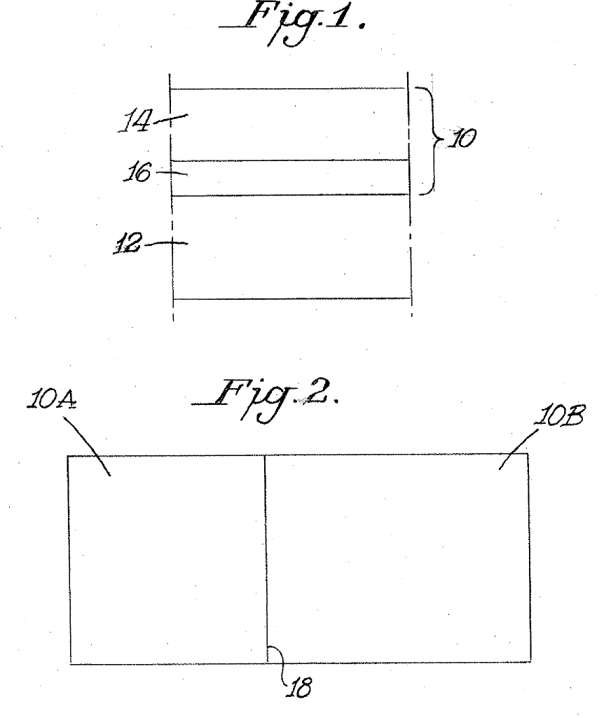

As shown in FIG. 1 liner 10 includes a top layer 14 and a bottom layer 16 mounted below and disposed against the top layer. Liner 10 could be formed in any suitable manner. In a preferred practice of this invention the top layer 14 and bottom layer 16 are co-extruded. Other techniques could be used such as forming the layers 14, 16 distinct from each other and then securing them together to form a laminate. What is important is that top layer 10 and bottom layer 16 are made of materials which are visually distinct from each other. As a result, when (through use) top layer 10 becomes worn, the bottom layer 16 begins to be visible through the top layer. The visual appearance of bottom layer 16 through the completely worn or still existing top layer 14 provides the indication that it is time to replace or repair the liner.

In practice, particularly with dump trucks, the wear is more pronounced at the back of the truck body nearer to the tail gate than at the front. As a result, the portion 10A of the liner nearer to the front of the truck might still have significant useful life while the portion 10B at the back of the truck has undergone significant wear. In accordance with one aspect of this invention when liner bottom layer 16 shows through the back portion 10B of the liner but is still not visible through the front portion 10A the back portion 10B might be removed and replaced by a different back portion 10B having greater amount of useful life. The two portions 10A and 10B can then be spliced together at splice line 18 or otherwise secured together in any suitable manner.

The invention could be practiced through the use of any suitable materials for top layer 14 and bottom layer 16. In a preferred practice of the invention contrasting colors are used for the two layers. For example, top layer 14 may be made of a gold color while bottom layer 16 is of a black color. Preferably, top layer 14 is substantially thicker than bottom layer 16 since one of the functions of bottom layer 16 is to be visible through the top layer when there has been significant wear of the liner 10. Thus, if top layer 14 is made too thin as compared to bottom layer 16, bottom layer 16 would show through when there is still a significant amount of useful life left in the liner. It is to be understood that the invention, however, may be broadly practiced where bottom layer 16 is thicker than top layer 14 or where both layers are of the same thickness. The preferred practice of the invention, however, would have top layer 14 about twice as thick as bottom layer 16. Or more specifically, top layer 14 could initially comprise 65% of the thickness of the unworn liner 10 while bottom layer 16 comprises 35% of the thickness. Other ranges include top layer 14 comprising 60-70% of the liner thickness with the bottom layer 16 being 30-40% of the thickness. Less preferred ranges are 50-80% for top layer 14 and 20-50% for bottom layer 16 or can be 40%-90% for top layer 14 and 10%-60% for bottom layer 16 or can be 25%-90% for top layer 14 and 10%-75% for bottom layer 16.

In a preferred practice of this invention top layer 14 is made of a heavy duty material while bottom layer 16 would be of a softer less rugged material. Top layer 14 could be made of a hard ultra-high molecular weight (UHMW) material which would be placed on top of a less expensive high molecular weight (HMW) bottom layer material.

While the use of contrasting colors is the preferred practice of having the top layer and bottom layer visibly distinct from each other, other forms of visible distinctness can be used. For example, such visible distinctness could be achieved through designs or patterns such as stripes or ornamentations in one or both layers which differ from each other. Instead of having contrasting colors different shades of the same color could be used which would provide a gradual indication of wear.

Since it is the top layer which is subjected to contact by the contents or materials placed in the vehicle body, it is preferred that the top layer be made of a heavy duty material. The bottom layer, however, could be made of a less expensive and lighter duty material such as a reprocessed material while the top layer is made of virgin material. The top layer could be made of a material having a low coefficient of friction to facilitate dispensing the contents from the vehicle body. Conversely, the bottom layer need not have a slippery lower surface since once it is anchored to the truck bed it would generally stay in place until physically removed. If desired, however, both layers could be made of the same materials and/or have the same coefficient of friction.

In the preferred practice of this invention the liner 10 is formed from only two layers, namely the top layer 14 and the bottom layer 16. The invention, however, could be practiced with more than two layers, such as one or more intermediate layers. Such intermediate layers could indicate a progression in the wear of the liner. In that regard, when an intermediate layer becomes visible through the top layer there is an early indication of wear. The need for actual repair or replacement of the liner, however, would not be necessary until the bottom layer begins to show through the one or more intermediate layers. As previously noted where the liner is used in a vehicle body that results in localized wear being more pronounced in one part of the body than in another such as by the portion of the liner 10B in the back of the vehicle body wearing faster than the front portion 10A, the portion 10A which is subjected to less wear could be retained and then connected such by being spliced at lateral splice line 18 (or can be connected in any other manner) to a replaced portion 10B.

The present invention provides a ready indication or first warning to the user that there is a significant amount of wear of the liner when the bottom layer 16 begins to show through the top layer and then provides an indication for the actual need for repair or replacement when such wear reaches a stage that the bottom layer is completely visible and there is no longer any portion of the top layer remaining above the bottom layer. At that time, an entirely new liner 10 or a portion thereof can be replaced in the vehicle body.

What is claimed is:

1. A wear indicating liner for a vehicle bed comprising a top layer, a bottom layer below and secured to said top layer, said top layer and said bottom layer having different initial thicknesses, said top layer being substantially thicker than said bottom layer, said top layer being made of a heavy duty material, and said top layer and said bottom layer being visually distinct from each other whereby said bottom layer begins to be visible after wear through said top layer to provide a visual indication of wear.

2. The liner of claim 1 wherein said top layer and said bottom layer are made of different colors to be visually distinct.

3. The liner of claim 1 wherein said top layer has a thickness of about 60-70% of the liner thickness and said bottom layer has a thickness of about 30-40%.

4. The liner of claim 1 wherein said bottom layer is made of a reprocessed material and said top layer is made of a virgin material.

5. The liner of claim 1 wherein said top layer has a lower coefficient of friction than said bottom layer.

6. The liner of claim 1 wherein said bottom layer is made of a softer material than said top layer.

7. The liner of claim 1 wherein said bottom layer and said top layer are co-extruded.

8. The liner of claim 1 wherein said top layer and said bottom layer are distinct layers laminated to each other.

9. The liner of claim 1 wherein said liner includes two separate longitudinal sections laterally spliced together.

10. The liner of claim 1 in combination with a vehicle having a body with a bed having a top surface, and said liner being mounted on said top surface to protect said bed.

11. A method of determining wear of a liner for a vehicle bed comprising providing a liner having a top layer and a bottom layer visibly distinct from each other, mounting the liner on the bed of a vehicle body with the top layer uppermost, periodically placing contents in the vehicle body on the top layer of the liner, and detecting significant wear of the liner when the bottom layer begins to be visible through the top layer.

12. The method of claim 11 wherein the top layer and bottom layer are made of different colors to be visibly distinct from each other.

13. The method of claim 11 wherein the top layer is thicker than the bottom layer.

14. The method of claim 11 wherein the top layer is made of virgin material and the bottom layer is made of reprocessed material.

15. The liner of claim 11 wherein the top layer is made of a heavy duty material and the bottom layer is made of a material softer than the top layer.

16. The method of claim 11 wherein the top layer and bottom layer are co-extruded together to form the liner.

17. The method of claim 11 wherein the top layer and the bottom layer are made separately from each other and laminated together to form the liner.

18. The method of claim 11 wherein after a significant amount of wear of a portion of the liner has been detected that portion of the liner is removed and replaced by a different portion which is spliced to the remaining portion of the liner.
